(19) United States
(12) Patent Application Publication
(10) Pub. No.: US 2024/0414036 A1
(43) Pub. Date: Dec. 12, 2024

(54) Electrical Device and System Having at Least Two Electrical Devices

(71) Applicant: Hilti Aktiengesellschaft, Schaan (LI)

(72) Inventor: Benjamin BÖHM, Weilheim (DE)

(21) Appl. No.: 18/702,110

(22) PCT Filed: Oct. 4, 2022
(86) PCT No.: PCT/EP2022/077555

§ 371 Date: Apr. 17, 2024

(30) Foreign Application Priority Data
Oct. 18, 2021 (EP) 21203145.4

(51) Int. Cl. H04L 27/00; H04B 3/54

(52) U.S. Cl. CPC H04L 27/0002; H04B 3/542

(57) ABSTRACT

An electrical device that is supplyable with electrical energy via a supply line includes an internal functional unit for transmitting data. The internal functional unit is configured to modulate data onto the supply line and/or to demodulate data from the supply line. The electrical device is a power tool or a vacuum cleaning apparatus or a water-management device or a feed apparatus or a charger.

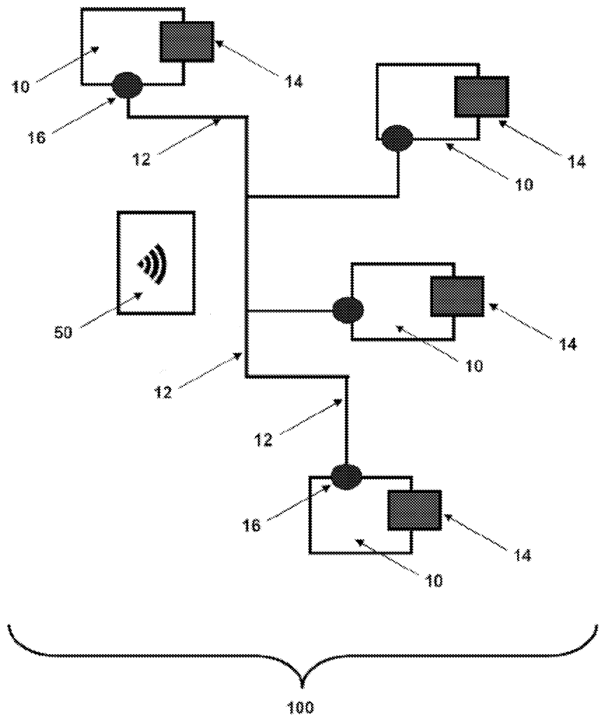

### BACKGROUND AND SUMMARY OF THE INVENTION

The invention relates to an electrical device that can be supplied with electrical energy via a supply line, wherein the electrical device has an internal functional unit for transmitting data, which internal functional unit is designed to modulate data onto the supply line and/or to demodulate data from the supply line. In a second aspect, the invention relates to a system composed of at least two proposed electrical devices, wherein a first electrical device has at least one first internal functional unit for modulating data onto the supply line, and a second electrical device has at least one second internal functional unit for demodulating data from the supply line. The electrical devices can exchange data with one another via the system they form, advantageously without the need for a direct connection between the electrical devices via a supply line. Instead, it is sufficient that the electrical devices that are meant to communicate with one another are connected to a shared electricity network, or that the supply lines form the shared electricity network.

In the power-tool sector, power tools are known for which the energy supply can be ensured via a public energy network or construction-site energy network. Line-powered power tools such as these can be used flexibly and with high performance as long as a public energy network or construction-site energy network is available. In addition to the line-powered power tools, cordless power tools are also being used increasingly on construction sites, for which the energy supply is ensured by means of batteries or rechargeable batteries (“power packs”). In the context of the invention, such power tools are preferably referred to as “battery-powered power tools”.

According to a more recent development in the power-tool sector, power tools are meant to be able to communicate with other devices on a construction site. A communication capability of this type, which is preferably referred to as “connectivity” in the context of the invention, can be provided particularly easily in battery-powered power tools by the power packs or batteries having a “smart” design, for instance. In the context of the invention, the term “smart” is understood to mean that smart power packs and/or batteries are capable of facilitating connectivity of the power tool to which they are connected to another device.

Since line-powered power tools do not have any power packs or batteries, the option of the “smart” form of batteries or power packs clearly does not exist for these. The object of the present invention is thus to provide an electrical device that is capable of communicating with other devices, in particular in its surrounding area. The object is also to specify a technical solution for facilitating the connectivity, which can be implemented in a particularly simple and straightforward manner, for example in the power-tool sector. A further object of the invention consists in specifying a communication system in which two or more electrical devices can communicate with one another.

According to the invention, an electrical device is provided that can be supplied with electrical energy via a supply line. The electrical device has an internal functional unit for transmitting data, which internal functional unit is designed to modulate data onto the supply line and/or to demodulate data from the supply line.

The electrical device can preferably have a connection via a supply line to an electricity network. For example, this may be a construction-site network or a public network for supplying electrical energy (“electricity network”). The connection between the electrical device and the electricity network need not always be in place, however, and can also be disconnected, for instance if the electrical device is meant to be used on another construction site and is meant to be transported there. Thus, the proposed electrical device can be supplied with electrical energy via a supply line. The proposed electrical device can preferably be connected to an electricity network via a supply line, which connection to the electricity network is preferably detachable. A power cable, which preferably has a first plug for connection to the electrical device and a second plug for connection to the electricity network, can be used, for example, as the supply line. This second connection can be realized, for instance, by means of a plug/outlet-socket connection. The electrical device preferably has an interface for receiving the first plug of the power cable. In the context of the invention, this preferably means that the electrical device can have a preferably mechanical interface for receiving a plug of the supply line. An essential advantage of the invention is that the power cable can be a commercially available power cable without technical modifications.

It is preferred according to the invention that the supply lines have power plugs that can be connected to interfaces of the electrical devices. This connection can be made in particular via a plug-in connection. The electrical devices can preferably use the proposed power cable to draw from an electricity network the energy they need for operation. The plug of the supply line is used in particular here to connect the power cable to the electrical device. In particular, the electrical device may be a power tool that is not battery-powered but can be connected to a public and/or construction-site energy network by a power cable. For example, a supply line which, in the context of the present invention, is also designed to transmit data can be used for this connection. The data transmission via the supply lines is preferably performed by modulating onto the supply lines, or demodulating from the supply lines, the data to be transmitted. The internal functional units of the electrical devices preferably perform this modulation or demodulation of the data.

The plug preferably comprises an electrical terminal arrangement, which has contacts. In a preferred configuration of the invention, the plugs of the supply lines constitute wired interfaces, with a socket of the plug having in particular two energy-supply contacts. In the context of the invention, the contacts can also be referred to as pins, with the terms “pin” and “contact” preferably being used synonymously in the context of the invention. The pins or the energy-supply contacts preferably form an electrical terminal arrangement of the plug, wherein the supply line can be connected via the electrical terminal arrangement or via the plug to an electrical device that is meant to be supplied with electricity.

Electrical devices that can be supplied with electrical energy via an electricity network are referred to as “line-powered” in the context of the invention. Line-powered electrical devices differ from battery-powered devices in that they usually do not have any batteries or rechargeable batteries (“power packs”) for supplying electrical energy.

It was surprising to those skilled in the art that the invention can provide a simple, cost-effective and uncomplicated way of upgrading electrical, preferably line-powered, devices for shared communication with one another. This advantage of the invention is achieved in particular by providing the at least one internal functional unit, which is designed to modulate data onto, and/or to demodulate data from, a supply line. In other words, the electrical device can comprise, for example, an internal functional unit for modulating data onto a supply line. The electrical device is thereby advantageously equipped to write data into the electricity network. Alternatively or additionally, the electrical device can comprise an internal functional unit for demodulating data from a supply line. The electrical device is thereby advantageously equipped to read data from the electricity network. The data exchanged between the electrical devices may be, for example, tool-related data such as operating parameters, identification codes, control commands or signals or indication commands or signals, position data (for instance GPS) or operating statuses such as “on” or “off”, without being restricted thereto.

Surprisingly, it has been found that the amount of effort required to obtain technical approval for an electrical device according to the invention is relatively small compared with conventional communication facilities between electrical devices as known from the prior art.

It is preferred according to the invention that the internal functional unit is designed to write and/or read data. The internal functional unit is capable in particular of feeding data into the supply line in the information technology sense, which is referred to as “writing data” or as “modulating” in the context of the invention. The internal functional unit can preferably also be designed to extract or read out data from the supply line in the information technology sense, which is referred to as “reading data” or “demodulating” in the context of the invention. The internal functional unit can preferably establish a connection between a WLAN source and the users of the communication system. According to the invention, however, it may also be preferred that the internal functional units produce a connection between the users of the proposed communication system, for instance between a power tool and a vacuum cleaner.

In a preferred configuration of the invention, the electrical device is selected from a group comprising power tool, vacuum cleaning apparatus, water-management device, feed apparatus and/or charger, without being restricted thereto. In principle, all the devices that are used on a construction site may be an electrical device according to the invention, although of course the invention is not restricted to uses in the construction-site sector. Indeed a system or a network of electrical devices according to the invention can be used in numerous technical fields. The electrical devices used on a construction site may be power tools such as drills, chisels, grinding or cut-off devices and/or slot cutters, or even auxiliary devices that are used to assist the work of the power tools. Such auxiliary devices may be, for example, the vacuum-cleaning apparatuses, water-management or water-recycling devices, feed apparatuses and/or chargers, without being restricted thereto. Chargers may be employed, for example, on those construction sites on which power tools or electrical devices that are powered by a power pack or battery are used in addition to those that are line-powered. The chargers can advantageously be used to charge up the power packs or batteries of these power pack-powered or line-powered electrical devices or power tools.

In a second aspect, the invention relates to a system composed of at least two proposed electrical devices, which electrical devices can be supplied with electrical energy via a supply line. A first electrical device has at least one first internal functional unit for modulating data onto the supply line, and a second electrical device has at least one second internal functional unit for demodulating data from the supply line. The definitions, technical effects and advantages introduced and described for the electrical device apply analogously to the proposed system, and vice versa.

It is preferred according to the invention that the electrical devices can exchange data with one another via the system they form. Advantageously, this does not require a direct connection between the at least two electrical devices via a supply line, but instead it is sufficient that the electrical devices that are meant to communicate with one another are connected to a shared electricity network, or that the supply lines between the electrical devices form the shared electricity network. The electrical devices that are meant to communicate with one another are preferably constituent parts of a shared electricity network, which shared electricity network preferably supplies electrical energy to the electrical devices of the proposed system. It is preferred according to the invention that the proposed system is also referred to as a “communication system”, “communication network” or “communication grid”.

Of course, the communication system can comprise more than two electrical devices, which may also be different electrical devices. The communication system can comprise, for example, different power tools, one or more vacuum cleaners and various charging apparatuses, with each electrical device having at least one internal functional unit. The internal functional units are preferably designed both for reading and for writing data. It is preferred according to the invention that the internal functional units of the individual electrical devices of the proposed communication system are designed just for reading or just for writing. In particular, the invention, which in particular consists in providing the internal functional units in the context of electrical devices, can facilitate connectivity of the preferably line-powered electrical devices involved. The internal functional units may preferably be substantially identical or substantially similar functional units. It may also be preferred, however, that the internal functional units are neither identical nor similar, provided they are suitable for modulating and/or demodulating data onto or from the supply lines.

The shared electricity network may be, for instance, a construction-site network or a public network for supplying electrical energy. An essential advantage of the invention is that a communication facility can be provided between electrical line-powered devices, which themselves do not need to have a direct wired connection to one another via data cables or electric power cables. In the context of the invention, the proposed system is preferably also referred to as a “network” or “grid”, which terms are used synonymously. An essential advantage of the invention is that the supply lines or power lines present between the preferably line-powered electrical devices involved are used for the data exchange. This preferably does not require any technical alterations to the supply lines or cables. Instead, the electrical devices involved in the proposed communication network comprise internal functional units for transmitting data, which internal functional units are designed to modulate data onto the supply line and/or to demodulate data from the supply line.

According to the invention, the first electrical device has at least one first internal functional unit for modulating data onto the supply line, and a second electrical device has at least one second internal functional unit for demodulating data from the supply line. Of course the electrical devices that form the proposed system, network or grid can each additionally have a further internal functional unit, which can perform the other function in each case. For example, if a first electrical device comprises a first internal functional unit for writing data into the electricity network, this first electrical device can additionally also comprise a further internal functional unit for reading data from the electricity network, i.e., an internal functional unit for demodulating data from the supply line. Conversely, a second electrical device, which comprises an internal functional unit for reading data from the electricity network, can additionally comprise a further internal functional unit for writing data into the electricity network, i.e., an internal functional unit for modulating data onto the supply line.

According to the invention, it is also preferred that the first internal functional unit of the first electrical device is designed in addition to writing or modulating data onto the supply line or into the electricity network, also to read or demodulate data from the supply line or from the electricity network. Analogously, according to the invention, it may be preferred that the second internal functional unit of the second electrical device is designed in addition to reading or demodulating data from the supply line or from the electricity network, also to write or modulate data onto the supply line or into the electricity network. An especially compact and space-saving electrical device can be provided by virtue of this multi-functionality of the internal functional units. Surprisingly, in this way an electrical device can be provided both for writing and for reading data even though the electrical device comprises only one internal functional unit.

The previously described communication system is preferably referred to as a wired communication system, network or grid. It is preferred according to the invention that a shared electricity network forms the basis of the wired communication system, network or grid, which shared electricity network supplies electrical energy at least to the at least two electrical devices that are constituent parts of the proposed wired communication system. Of course, the electricity network can also supply electrical energy to further electrical devices. The proposed communication system can preferably comprise the shared electricity network that supplies electrical energy or electricity at least to the at least two electrical devices involved. In other words, the shared electricity network to which the at least two electrical devices of the proposed communication system are connected by supply lines may be a constituent part of the proposed communication system. The proposed communication system can advantageously form a local energy and communication network, in which data is exchanged between the preferably line-powered electrical devices by means of internal functional units of the electrical devices and the supply lines between the electrical devices. The communication system preferably constitutes a carrier-frequency installation or a carrier-frequency apparatus, which can be realized by means of the internal functional units.

The modulation and/or demodulation of the data or of the data signals is preferably performed in the radiofrequency band, i.e., a band of preferably 100 to 150 kHz, particularly preferably at about 120 kHz. It is preferred according to the invention that the communication system has a range of up to 1000 m, preferably up to 600 m and most preferably up to 400 m. In addition, transmission performances or rates of up to 2500 Mbit/s, preferably up to 2000 Mbit/s, can be achieved by the communication system.

It is preferred according to the invention that the internal functional units of the electrical devices involved in the communication system are capable of modulating data in the radiofrequency band onto the electricity network or the supply line, and/or demodulating data in the radiofrequency band from the electricity network or from the supply line. The modulated data which the internal functional units of the electrical devices feed into the underlying electricity network preferably constitutes low-level harmless interference within the electricity network or within the local energy and communication network. This interference advantageously lies in a tolerance range of electromagnetic compatibility so that it is not hazardous to humans nor does it interfere with or impair other forms of communication and communication protocols being used in the surrounding area of the local energy and communication network. In particular, nor does the interference affect the electrical supply to the electrical devices involved.

The internal functional units may preferably be permanently inbuilt in the electrical devices of the proposed communication system. Nonetheless, the internal functional units may also be exchangeable modules, which can be detachably fastened to the electrical device temporarily. In this preferred configuration of the invention, the internal functional units can be exchanged particularly easily, for instance in the event that an internal functional unit is broken or must be removed after the passage of time or for other purposes.

It is preferred according to the invention that the system has a gateway for wireless communication. The gateway can preferably be designed to communicate with mobile communication apparatuses and/or a cloud. Providing the gateway constitutes an expansion of the previously described wired communication system. The communication system that has a gateway is preferably referred to as an “expanded communication system, network or grid” in the context of the invention. Expanding the wired communication system by a gateway can create a wireless communication facility to further electrical devices or a cloud, so that data can be exchanged not only by wired means between the users of the proposed wired communication system but advantageously also wirelessly with mobile communication apparatuses and/or a cloud. The mobile communication apparatuses outside the wired communication system may be, for example, cell phones, smartphones, tablet PCs, laptops, Notebooks, Palm PCs or the like, without being restricted thereto.

It is an essential advantage of the gateway-expanded communication system that external access to the preferably line-powered electrical devices of the wired communication network is possible by means of the gateway. Whereas the electrical devices involved can communicate with one another by means of the internal functional units via the supply lines (“wired communication system, network or grid”), external, i.e., remote, access to the electrical devices is possible via the gateway (“expanded communication system, network or grid”). Machine-related data such as operating times, maintenance indicators, operating or fault parameters, operating statuses etc. can thereby be retrieved externally or can be conveyed from the electrical devices to the outside world, which is not part of the wired communication network. In particular, the external devices or the cloud that want to communicate via the gateway with the electrical devices of the communication system do not have to share a power connection or supply connection with the electrical devices, nor do the external devices or the cloud that want to communicate via the gateway with the electrical devices of the communication system have to be part of the shared electricity network that forms the basis of the proposed communication network.

A further advantage of the gateway-expanded communication system is that the gateway can be exchanged in an especially simple and uncomplicated manner if another wireless communication standard is meant to be used for the external communication with the electrical devices. Future-oriented, new transmission technologies can thereby be implemented especially easily in existing communication systems or networks without the need to exchange all the electrical devices or carry out costly conversion work on the electrical devices. In a preferred configuration of the invention, the gateway is designed to communicate via Bluetooth, in particular low energy Bluetooth (BLE).

Further advantages will become apparent from the following description of the FIGURE. The FIGURE, the description and the claims contain numerous features in combination. A person skilled in the art will expediently also consider the features individually and combine them to form useful further combinations.

### BRIEF DESCRIPTION OF THE DRAWING

The FIGURE shows a view of a preferred configuration of the communication system.

### DETAILED DESCRIPTION OF THE DRAWING

Identical and similar components are denoted by the same reference signs in the FIGURE.

The FIGURE shows a preferred embodiment of a proposed communication system 100. The proposed communication system 100 has at least two electrical devices 10, which may be, for instance, power tools, vacuum cleaners, chargers, auxiliary devices or the like. The electrical devices 10 of the communication system 100 are connected to supply lines 12, which supply lines 12 form a shared electricity network, which forms the basis of the proposed communication system 100. The supply lines 12 are preferably designed to supply electrical energy, i.e., electricity, to the electrical devices 10. The supply lines 12 can preferably belong to a public electricity network or a construction-site electricity network. The supply lines 12 preferably have plugs or power plugs, which can be received by interfaces 16 of the electrical devices 10. The interfaces 16 are preferably mechanical interfaces, which in particular make it possible to form a plug-in connection between the plug and the interface 16 of the electrical device 10.

The electrical devices 10 of the communication system 100 also have internal functional units 14, by means of which the electrical devices 10 can exchange data with one another. The data exchange between the electrical devices 10 takes place in particular by wire-based or wired means via the supply lines 12, which preferably form a shared electricity network between the electrical devices 10 that are meant to communicate with one another.

In order to be able to access the electrical devices 10 of the communication system 10 externally, in a preferred configuration the communication system 100 can have a gateway 50. By means of the gateway 50, a communication link can be provided between the gateway 50 and the electrical devices 10, or between the electrical devices 10 and the outside world. In particular, the electrical devices 10 can communicate with a cloud or with mobile communication apparatuses, for example, by means of the gateway 50. This communication link to the outside world, i.e., the world outside the preferably wired communication network 100, in particular facilitates external access to the electrical devices 10, for instance so that external devices can read out tool-related data such as device running times, maintenance requirements, fault messages or the like.

### LIST OF REFERENCE CHARACTERS

10 electrical device
12 supply line
14 internal functional unit
16 interface for a plug of the supply line
50 gateway
100 communication system

1.-7. (canceled)

8. An electrical device (10) that is supplyable with electrical energy via a supply line (12), comprising:
an internal functional unit (14) for transmitting data, wherein the internal functional unit (14) is configured to modulate data onto the supply line (12) and/or to demodulate data from the supply line (12).

9. The electrical device (10) as claimed in claim 8, wherein the internal functional unit (14) is configured to write and/or read data.

10. The electrical device (10) as claimed in claim 8, wherein the electrical device (10) is a power tool or a vacuum cleaning apparatus or a water-management device or a feed apparatus or a charger.

11. The electrical device (10) as claimed in claim 8, further comprising an interface (16) for receiving a plug of the supply line.

12. A system (100), comprising:
a first electrical device (10) that is supplyable with electrical energy via a first supply line (12); and
a second electrical device (10) that is supplyable with electrical energy via a second supply line (12);
wherein the first electrical device (10) has a first internal functional unit (14) for modulating data onto the first supply line (12);
wherein the second electrical device (10) has a second internal functional (14) unit for demodulating data from the second supply line (12).

13. The system (100) as claimed in claim 12, further comprising a gateway (50) for wireless communication.

14. The system (100) as claimed in claim 13, wherein the gateway (50) is configured to communicate with a mobile communication apparatus and/or a cloud.
